(19) United States
(12) Patent Application Publication
(10) Pub. No.: US 2008/0002534 A1
(43) Pub. Date: Jan. 3, 2008

(54) Optical disc/disk drive control system

(75) Inventor: Che-Sheng Lin, Pan Chiao City (TW)

Correspondence Address: BIRCH STEWART KOLASCH & BIRCH, PO BOX 747, FALLS CHURCH, VA, 22040-0747, US

(73) Assignee: REALTEK SEMICONDUCTOR CORP., Hsinchu (TW)

(21) Appl. No.: 11/812,042

(22) Filed: Jun. 14, 2007

(30) Foreign Application Priority Data
Jun. 16, 2006 (TW) 095121537

(51) Int. Cl. G11B 7/00

(52) U.S. Cl. 369/44.11

(57) ABSTRACT

The invention provides a tracking servo control system and a tracking control method for detecting a land pre-pit signal. According to the system and the method, a laser beam is moved to a location adjacent to the land-pre-pit and detects the land-pre-pit signal at the location. A tracking servo control system includes an analog front end, a groove control unit, a digital servo processor and a power driver.

### BACKGROUND OF THE INVENTION

(a) Field of the Invention

The invention relates to an optical disc/disk drive control system, and particularly to an optical disc/disk drive tracking servo control system.

(b) Description of the Related Art

FIG. 1A shows a schematic diagram of the groove structure of a blank optical disc/disk compliant with the -R or -RW specification of a general digital versatile disc/disk, DVD (hereinafter referred to as DVD-R/RW). The groove structure Dsk1 of the blank optical disk/disc includes a groove G, two wobble edge lines W along the two edges of the groove G, two lands L, and a land-pre-pit (LPP) Lpp etched on one of the land before the optical disc/disk leaves the factory. The area covered by the groove G is used to burn the data to be stored. Before burned, the area covered by groove G is a space block S. When the optical disc/disk drive is reading data from or writing data into the optical disc/disk, the two wobble lines W are used to perform track locking and to provide information, such as the rotational speed of the optical disc/disk and so forth, for the optical disc/disk drive. When the optical disc/disk drive is burning data into the optical disc/disk, the optical disc/disk drive detects the land-pre-pit Lpp on the land L to acquire a land-pre-pit signal LPPS in order to acquire the data in the land-pre-pit Lpp, such as the land-pre-pit Lpp address and so forth, so that the optical disc/disk drive system can acquire a burning starting address. Of course, some specific land-pre-pit Lpp provides other information regarding the optical disc/disk to the optical disc/disk drive, such as the burning speed, burning strategy, and so forth.

As shown in FIG. 1B, an optical processing unit (not shown in the figure) irradiates a laser beam LSR onto the groove G when the optical disc/disk drive starts to burn a blank optical disc/disk DSK1 in compliance with the DVD-R/RW specification. When the laser beam LSR irradiates onto the land-pre-pit Lpp (i.e. the black area enclosed by the dash-lined block DET), the light reflected by the land-pre-pit Lpp, which is dim that is almost like no reflecting light or a scattering light, irradiates on four blocks A, B, C, and D by an optical sensing diode with four sensing divisions in an optical electronic integrated circuit, OEIC (not shown in the figure) so that the lights from the four light beam blocks are then converted into voltages, respectively. These voltages are then processed into a (A+B)-(C+D) signal by a push pull signal generator (not shown in the figure) in order to obtain the land-pre-pit Lpp address information included in the land-pre-pit signal LPPS. As seen in the figure, most of the light beam received from the blocks A, B, C, and D are bright and only the light reflected from the land-pre-pit Lpp is dark. Since the contrast between the bright portion and the dark portion is obvious, the optical disc/disk drive can easily acquire the land-pre-pit Lpp address included in the land-pre-pit signal LPPS. Therefore, the optical disc/disk drive can precisely locate the starting address of burning and proceed the subsequent data write-in operations when the optical disc/disk is burning a blank DVD-R/RW optical disc/disk.

FIG. 1C shows a schematic diagram illustrating the groove structure of an optical disc/disk after burned in compliance with the DVD-R/RW specification. The groove structure DSK1′ is similar to the groove structure DSK1 shown in FIG. 1A. The difference is that the groove structure DSK1′ includes a plurality of mark blocks M. When the optical disc/disk drive is burning the blank DVD-R/RW optical disc/disk, it initially decodes the land-pre-pit signal LPPS which includes the land-pr-pit Lpp address. Then, an optical processing unit is used to emit a laser beam LSR with higher power intensity. The laser beam LSR then goes through lens refraction to irradiate onto a space block S so as to create a small section of laser engraving mark, that is the mark block M shown in the FIG. 1C. When the optical disc/disk drive uses the processing unit to read the data from the optical disc/disk, it utilizes the light intensity difference reflected from the space block S and the mark block M to recognize the 1 (bright) and 0 (weak) encoding of the stored data. Then, a microprocessor (not shown in the figure) converts these data into corresponding texts, images, sounds, etc.

It should be noted that the optical disc/disk drive still has to decode the land-pre-pit signal LPPS including the land-pre-pit Lpp address in advance when the optical disc/disk drive intends to repeatedly burn a burned optical disc/disk according to the DVD-R/RW specification. However, as shown in FIG. 1D, a mark block M at the corresponding location of the land-pre-pit Lpp of the groove G on a burned optical disc/disk may already exist. At the time, the blocks A, B, C, and D of the four-division light sensing diode of the optical electronic integrated circuit receive the light reflected by the land-pre-pit Lpp and the mark block M, simultaneously. As clearly shown in the figure, the black area formed by the mark block (the dash-lined block DER) is far larger than the black area formed by the land-pre-pit (the dash-lined block DET). Therefore, the amplitude of the land-pre-pit signal LPPS detected by the optical disc/disk drive becomes small such that the optical disc/disk drive is not able to clearly identify the current read-in data as either the land-pre-pit signal LPPS or the radio frequency signal of the mark block M. Under such condition, the signal/noise ratio (S/N) of the land-pre-pit signal becomes small and the optical disc/disk drive cannot get the data of the required starting LPP address correctly for burning to easily result in burning failure.

### BRIEF SUMMARY OF THE INVENTION

In view of the problems of the prior art, one object of the invention is to provide a tracking control system in an optical disc/disk drive and a tracking control method for detecting the land-pre-pit signal to improve the success rate of detecting the land-pre-pit signal when the optical disc/disk drive burns a disk.

One embodiment according to the invention discloses a tracking control system, for tracking control when an optical disc/disk drive burns an optical disc/disk according to the DVD-R/RW specification. Of course, the tracking control mechanism of the tracking control system can also be used while reading the optical disc/disk, depending on the needs. The tracking control system comprises an optical processing unit, an analog front end device, a groove control unit, a digital servo processor, and a driving device. The optical processing unit generates a plurality of analog receiving signals according to at least one reflected light from the optical disc/disk irradiated by a laser beam emitted from the processing unit itself. The analog front end device receives the plurality analog receiving signals to generate a push pull signal and an analog tracking error signal according to the plurality of analog receiving signals. The groove control unit receives the push pull signal to generate a groove deviating signal according to the push pull signal. The groove control unit also judges whether the optical disc/disk drive decides to execute the operation of detecting the land-pre-pit signal or not. If the optical disc/disk drive decides to detect the land-pre-pit signal, the groove control unit uses the groove deviating signal to enable subsequent circuitries, outputs the groove deviating signal, or sets the groove deviating signal as 1. If the optical disc/disk drive decides not to detect the land-pre-pit signal, the groove control unit uses the groove deviating signal to disable the subsequent circuitries, stops outputting the groove deviating signal, or sets the groove deviating signal as 0. The digital servo processor converts the analog tracking error signal into a digital tracking error signal via analog-to-digital conversion, sums the groove deviating signal and the digital tracking error signal, and performs signal equalizing based on the sum and digital-to-analog conversion to generate an analog groove servo control signal. The driving device generates a driving signal according to the analog groove servo control signal to control the position on a groove of the optical disc/disk on which the laser beam emitted by the processing unit irradiates.

Furthermore, the another embodiment of the invention discloses a tracking control method for detecting the land-pre-pit signal in the burning of the optical disc/disk according to the DVD-R/RW specification, comprising the following steps. At first, a laser beam is provided to irradiate onto an optical disc/disk groove. The laser beam is positioned at the center of the groove where the center of the groove has a first distance from an edge of the groove having the land-pre-pit. Then, a groove deviating signal is provided to move the laser beam located at the center of the groove so that the position of the laser beam is offset to a second distance from the edge of the groove having the land-pre-pit, where the second distance is shorter than the first distance.

The tracking control system and the tracking control method for detecting the land-pre-pit signal according to embodiments of the invention discloses having the offset of the laser beam emitted by the processing unit towards the land-pre-pit position before detecting the land-pre-pit signal and thus increasing the covering area of the light reflecting back to the processing unit from the land-pre-pit to improve the success rate of detecting the land-pre-pit signal of the optical disc/disk drive and to thereby obtain the burning start address information of the optical disc/disk drive accurately.

### BRIEF DESCRIPTION OF THE DRAWINGS

FIG. 1A shows a schematic diagram illustrating a groove structure of a blank optical disc/disk compliant with the DVD-R/RW specification.

FIG. 1B shows a schematic diagram illustrating a laser beam irradiating onto a blank optical disc/disk compliant with the DVD-R/RW specification.

FIG. 1C shows a schematic diagram illustrating a groove structure of a burned optical disc/disk compliant with the DVD-R/RW specification.

FIG. 1D shows a schematic diagram illustrating a laser beam irradiating onto a burned optical disc/disk compliant with the DVD-R/RW specification.

FIG. 2A shows a schematic diagram illustrating a tracking control system used in a optical disc/disk drive according to one embodiment of the invention.

FIG. 2B shows a schematic diagram illustrating a laser beam position when detecting a land-pre-pit signal of a tracking control system according to prior art.

FIG. 2C shows a schematic diagram illustrating a laser beam position when detecting a land-pre-pit signal of a tracking control system according to one embodiment of the invention.

FIG. 2D shows a schematic diagram illustrating the reading of land-pre-pit signal on a blank optical disc/disk and a burned optical disc/disk according to prior art and the tracking control method used to read the land-pre-pit signal according to one embodiment of the invention.

FIGS. 3A and 3B show a schematic diagram illustrating the flow chart of a tracking control method for detecting land-pre-pit signal according to one embodiment of the invention.

FIG. 4 shows a schematic diagram illustrating the flow chart of a groove servo signal generating method according to one embodiment of the invention.

FIGS. 5A and 5B show a schematic diagram illustrating the flow chart of a tracking pre-adjustment method for detecting land-pre-pit signal according to the invention.

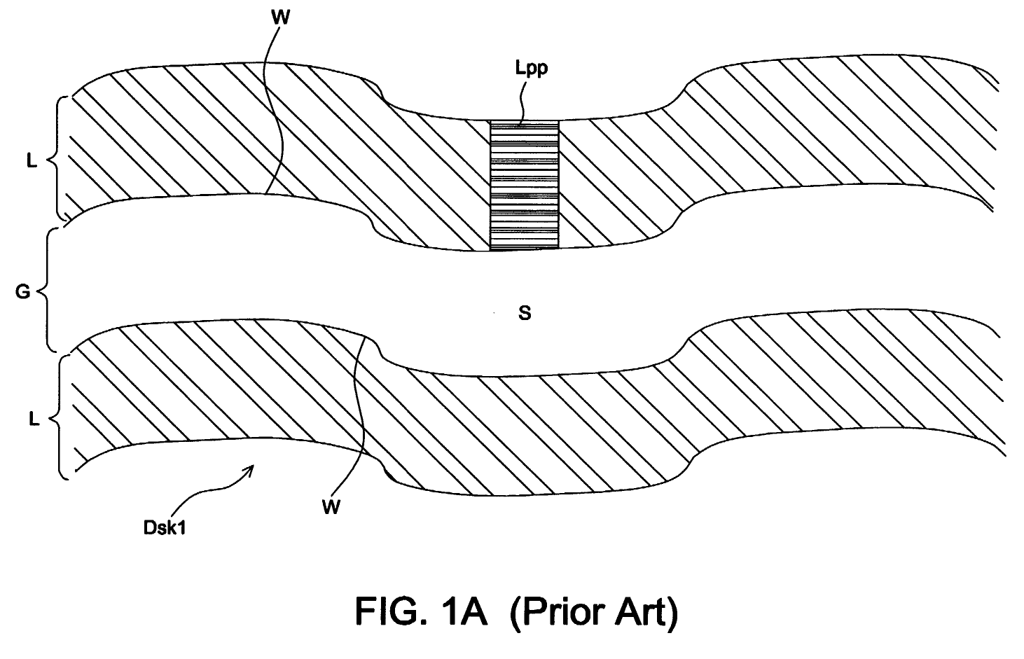

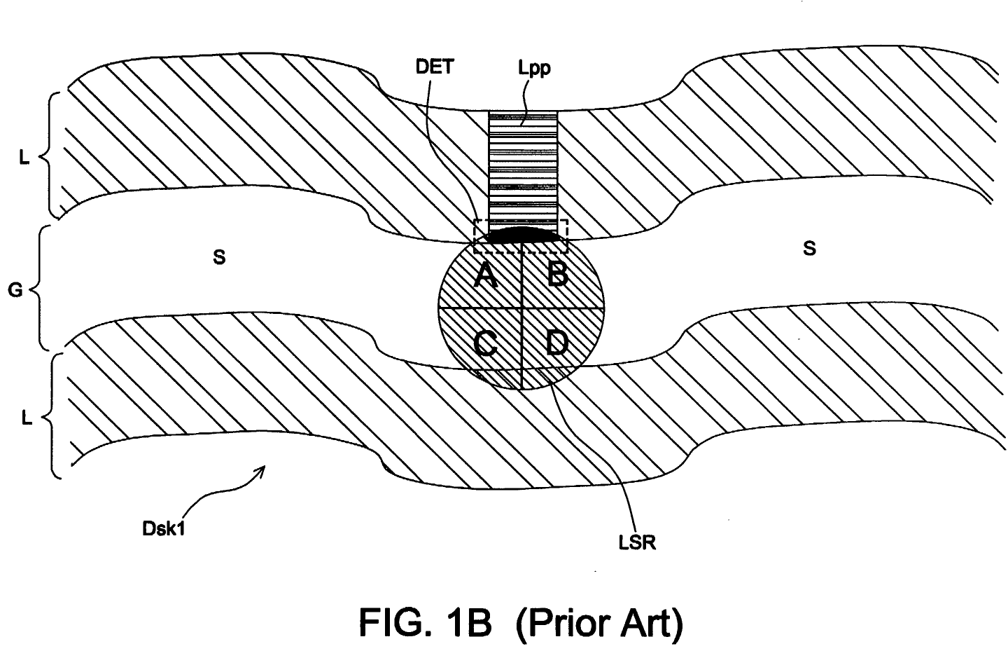

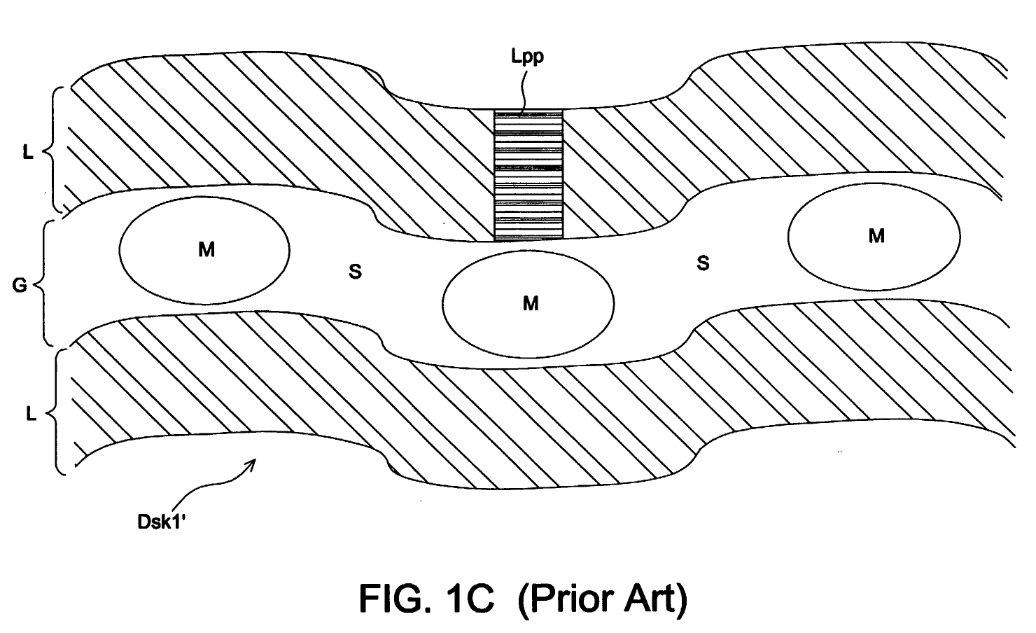

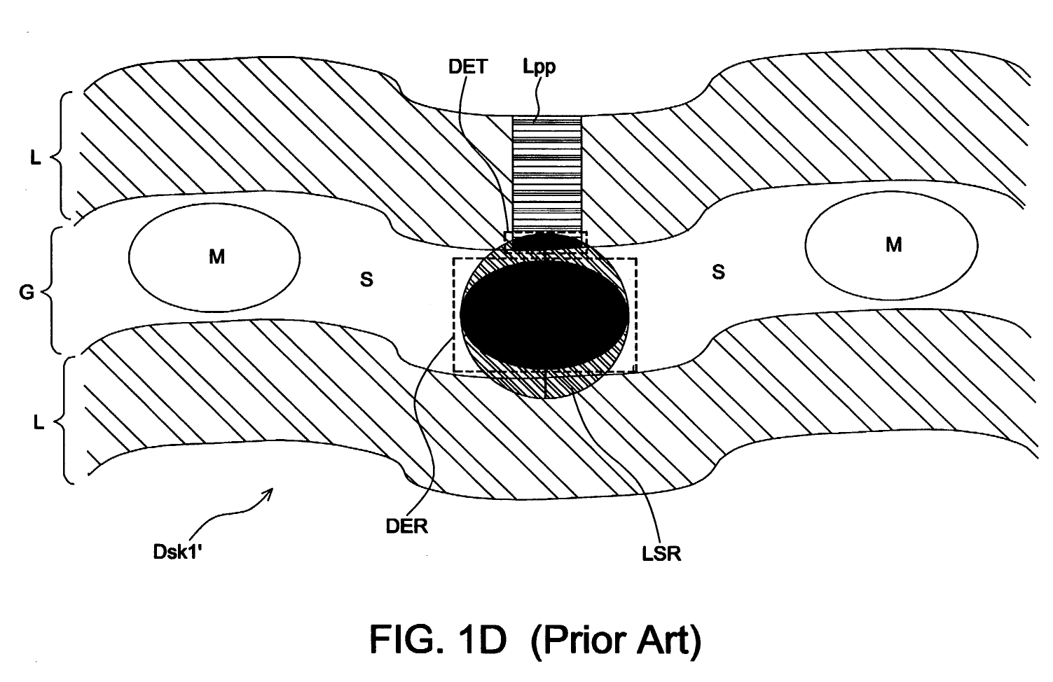

### DETAILED DESCRIPTION OF THE INVENTION

The following illustrating diagrams give detail descriptions about the tracking control system, the tracking control method for detecting the land-pre-pit signal, and the groove servo control signal generating method according to the present invention.

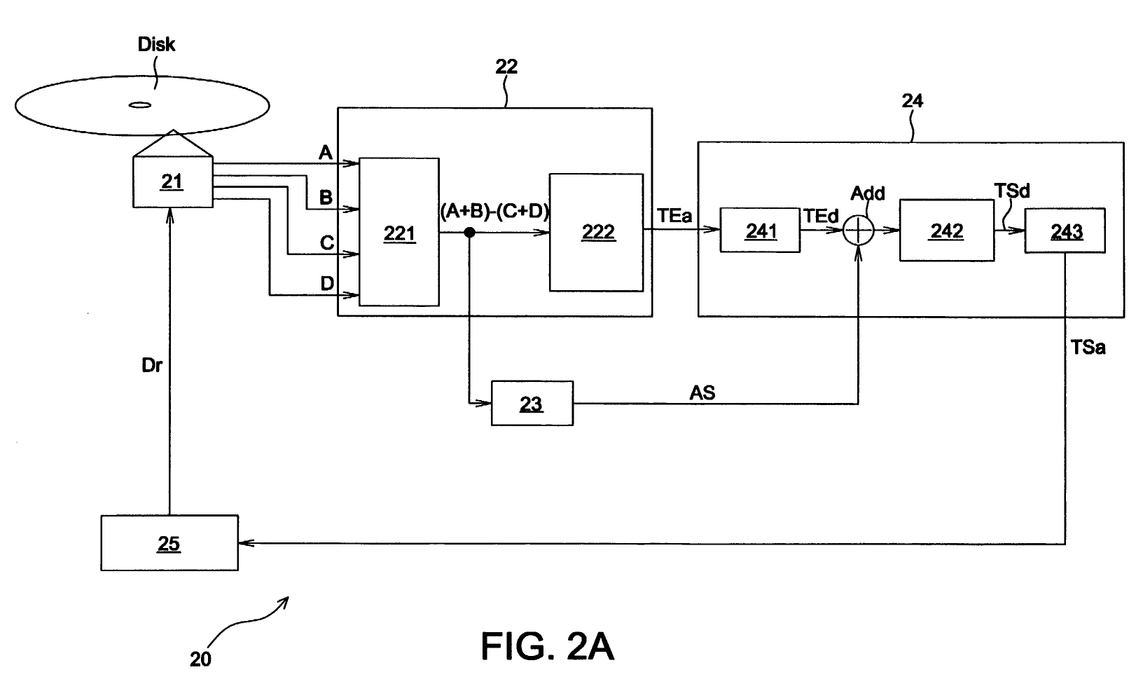

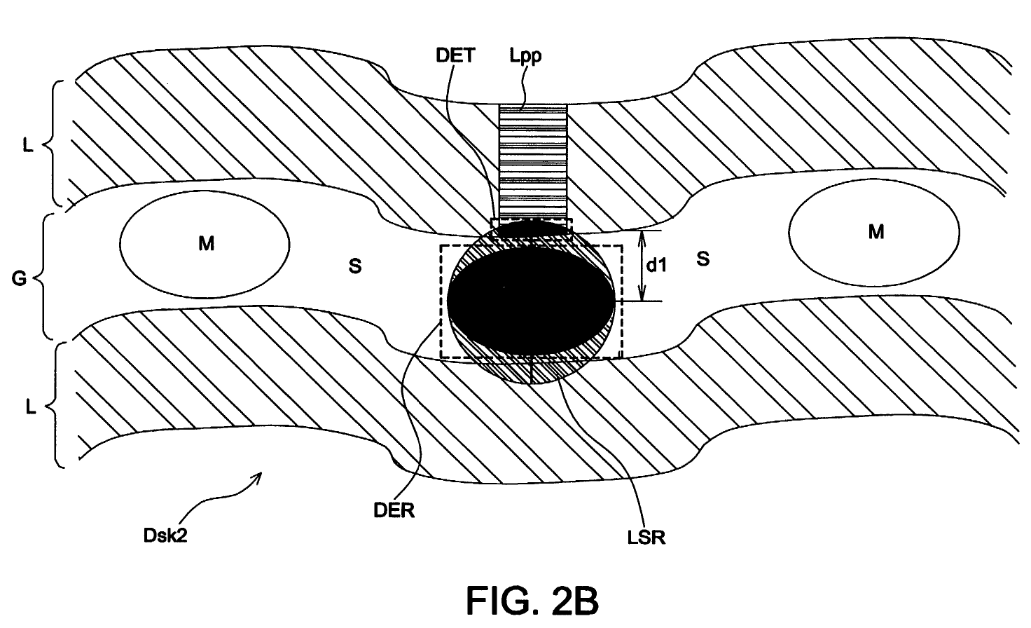

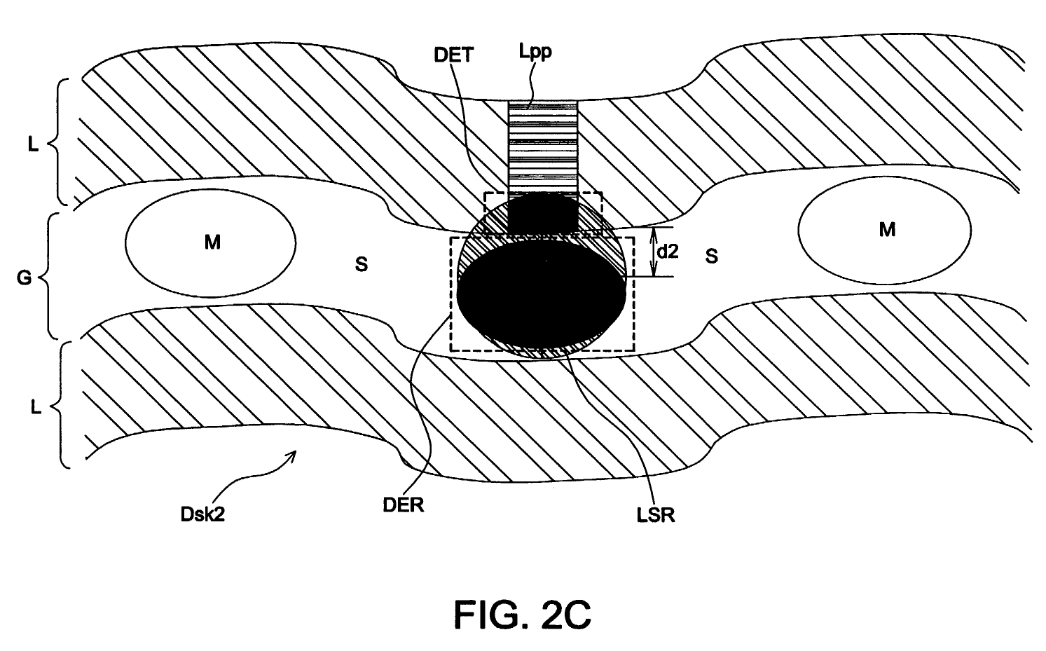

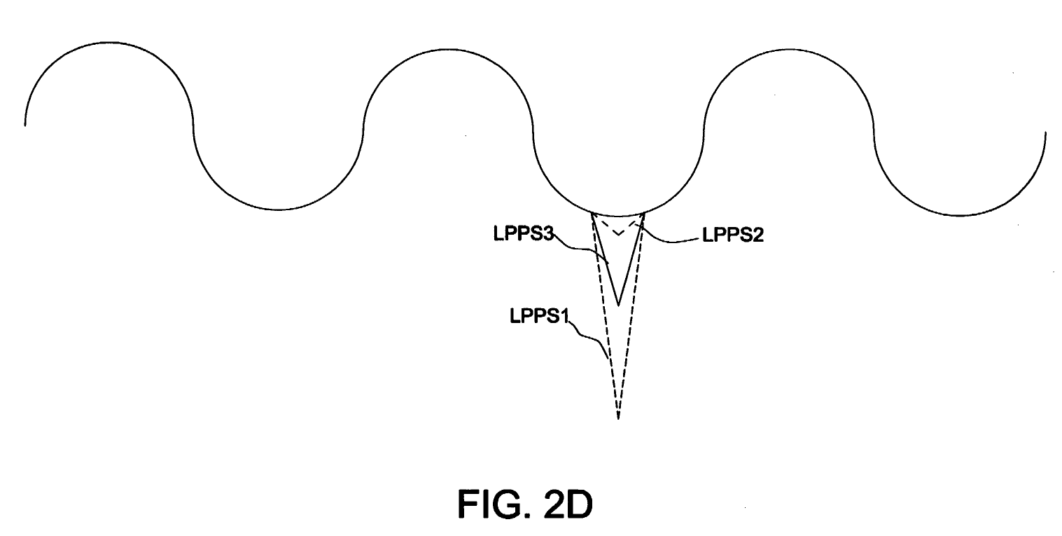

FIG. 2A illustrates a tracking control system 20 according to one embodiment of the invention. The tracking control system 20 is used to perform tracking control when an optical disc/disk drive burns an optical disc/disk according to the DVD-R/RW specification. Of course, the tracking control mechanism of the tracking control system 20 can also be used in reading the optical disc/disk, depending on the needs. The tracking control system 20 comprises an optical processing unit 21, an analog front end device 22, a groove control unit 23, a digital servo processor 24, and a driving device 25.

The processing unit 21 generates a plurality of analog receiving signals A,B,C,D,E,F, . . . according to at least one reflected light from the optical disc/disk irradiated by a laser beam emitted from the processing unit 21 itself. The four A, B, C, and D signals generated by the zero order diffraction are usually used by the back end circuitries.

The analog front end device 22 comprises a series of circuitries to receive the plurality analog signals A,B,C,D,E,F, . . . from the processing unit 21, perform mathematical calculations, filter signal noises, and correct the offset value, amplifying signals, and etc., for generating analog servo control signals, such as focusing error (FE), analog tracking error (TE), central error (CE), and etc., according to the plurality of analog signals. Since the invention is about the tracking control system, only circuitries related to the tracking control system are illustrated in FIG. 2A. As shown in this figure, the analog front end device 22 includes a push pull signal generator 221 and a tracking error signal generator 222. The push pull signal generator receives analog receiving signals A, B, C, and D to generate a push-pull signal (A+B)-(C+D) by processing the analog receiving signals A,B,C,D. The tracking error signal generator 222 receives the push-pull signal (A+B)-(C+D) to generate an analog tracking error signal TEa according to the push-pull signal (A+B)-(C+D).

The groove control unit 23 receives the push-pull signal (A+B)-(C+D) to generate a groove deviating signal AS according to the push pull signal (A+B)-(C+D). It should be noted that the groove deviating signal can be a digital signal and can also be a bias or an offset. The groove control unit 23 also judges whether the optical disc/disk drive decides to perform the operation of detecting the land-pre-pit signal LPPS. If the optical disc/disk drive decides to detect the land-pre-pit signal LPPS, the groove control unit 23 uses the groove deviating signal AS to enable the subsequent circuitries. On the other hand, if not, the groove control unit 23 uses the groove deviating signal AS to disable the subsequent circuitries. Of course, the groove control unit 23 can also select one of the following approaches after it judges whether the optical disc/disk drive decides to perform the operation of detecting the land-pre-pit signal or not:

1. When the optical disc/disk drive decides to perform the operation of detecting the land-pre-pit signal LPPS, the groove control unit 23 outputs the groove deviating signal AS; and if the optical disc/disk drive decides not to detect the land-pre-pit signal LPPS, it stops outputting the groove deviating signal AS.

2. When the optical disc/disk drive decides to perform the operation of detecting the land-pre-pit signal LPPS, the groove deviating signal AS outputted by the groove control unit 23 is set as 1, that is, this signal will influence the subsequent circuitries; and if the optical disc/disk drive decides not to detect the land-pre-pit signal LPPS, the groove deviating signal AS outputted by the groove control unit 23 is set as 0, that is, this signal will not influence the subsequent circuitries.

The digital servo processor 24 receives the analog tracking error signal TEa and the groove deviating signal AS to generate analog tracking error signal TSa. The digital servo processor 24 includes an analog-to-digital converter (ADC) 241, an adder Add, a tracking servo equalizer 242, and a digital-to-analog converter (DAC) 243. The analog-to-digital converter 241 receives the analog tracking error signal TEa and converts it into a digital tracking error signal TEd. The adder Add sums the digital tracking error signal TEd and the groove deviating signal AS to generate a sum TEd+AS. The tracking servo equalizer 242 generates a digital groove servo signal TSd according to the sum TEd+AS of the digital tracking error signal TEd and the groove deviating signal AS. The digital-to-analog converter 243 receives the digital groove servo control signal TSd and converts the digital groove servo control signal TSd into an analog groove servo control signal TSa. It should be noted that the digital servo processor 24 may not perform digital-to-analog conversion so that the final output groove servo control signal can be a digital signal.

The driving device 25 generates a driving signal Dr according to the analog groove servo control signal TSa to control the position on a groove of the optical disc/disk on which the laser beam LSR emitted by the processing unit 21 irradiates.

Referring to FIGS. 2A, 2B, 2C, and 2D simultaneously, the operation of the tracking control system 20 for optical disc/disk drive according to one embodiment of the invention is described in detail. FIGS. 2B and 2C illustrate the same DVD-R/RW optical disc/disk Dsk2 that has already been burned. FIG. 2D illustrates the reading of the land-pre-pit signal LPPS from a blank optical disc/disk and a burned optical disc/disk according to the tracking method of the prior art and the tracking method for reading the land-pre-pit signal LPPS according to one embodiment of the invention. As shown in FIG. 2D, LPPS1 and LPPS2 are the land-pre-pit signals read from a blank optical disc/disk and a burned optical disc/disk, respectively, according to the tracking method of the prior art. On the other hand, LPPS3 is the land-pre-pit signal read from a burned optical disc/disk according to the tracking method of the invention.

When the optical disc/disk drive reads the optical disc/disk Dsk2 and irradiates the laser beam LSR onto the groove G by using the processing unit 21, the push pull signal generator 221 of the tracking control system 20 generates a push pull signal (A+B)-(C+D) according to the four analog receiving signals A, B, C, and D. The push pull signal (A+B)-(C+D) can be just equal to zero (meaning that the laser beam LSR has been locked on the groove G exactly); or not equal to zero as the laser beam is not locked on the groove G. Assuming that the push pull signal (A+B)-(C+D) is not equal to zero, the tracking control system 20 adjusts the relative position between the laser beam LSR and the groove G so that the laser beam locks on the groove G exactly to complete the tracking operation and the push pull signal (A+B)-(C+D) is equal to zero. Therefore, the error generated by the unbalance among the four analog receiving signals A, B, C, and D can be reduced. After the push pull signal (A+B)-(C+D) is adjusted to be zero, the tracking error signal generator 222 generates an analog tracking error signal TEa (that is equal to zero, TEa=0) according to the push pull signal (A+B)-(C+D). Then, the analog-to-digital converter 241 converts the analog tracking error signal TEa into a digital tracking error signal TEd. Thus, TEd is also equal to zero. Since the optical disc/disk drive is under reading status, the major task for the optical disc/disk drive is to read the information in the groove. Therefore, the groove control unit 23 disables the subsequent circuitries by utilizing the groove deviating signal AS, stops outputting the groove deviating signal AS, or sets the generated groove deviating signal AS to be zero. Therefore, the groove deviating signal AS does not influence the subsequent circuitries. Through the subsequent processes by the tracking servo equalizer 242 and the digital-to-analog converter 243, an analog tracking error signal TSa is generated and the laser beam LSR emitted from the processing unit 21 is locked at the center of the groove G via the driving device 25. In addition, the center of the laser beam has a first distance d1 apart from the side edge of the groove having the land-pre-pit, as shown in FIG. 2B.

When the optical disc/disk drive is ready to burn the optical disc/disk Dsk2 and starts to detect the land-pre-pit signal LPPS, the groove control unit 23 enables the subsequent circuitries by utilizing the groove deviating signal AS, outputting the groove deviating signal AS, or sets the generated groove deviating signal AS to be 1 to output a bias or an offset, such as outputting a bias equal to 3. Thus, the adder Add sums the digital tracking error signal Ted=0 and the groove deviating signal AS=3 to generate a sum TEd+AS=3. The generated analog groove servo control signal TSa is changed through the processes by the tracking servo equalizer 242 and the digital-to-analog converter 243. Then, the driving device 25 receives the changed analog groove servo control signal TSa and generates a corresponding driving signal Dr according to the changed analog groove servo control signal TSa. Finally, the driving signal Dr locks the laser beam LSR emitted by the processing unit 21 to be offset from the center of groove G near the land-pre-pit position. The center position of the laser beam LSR has a second distance d2 apart from the side edge of the groove having the land-pre-pit Lpp, as shown in FIG. 2C, where the second distance d2 is smaller than the first distance d1. After the position of the laser beam LSR is locked at the position offset from the center of the groove G, the optical disc/disk drive is ready to detect the land-pre-pit Lpp.

As shown in FIGS. 2B and 2C, the area covered by the light reflected back to the processing unit 21 from the land-pre-pit Lpp, shown in FIG. 2C (the black area enclosed by the dash-lined block DET in FIG. 2C) is much larger than that in FIG. 2B (the black area enclosed by the dash-lined block DET in FIG. 2B). Therefore, as shown in FIG. 2D, the amplitude of the land-pre-pit signal LPPS3 corresponding to FIG. 2C is much lager than that of the land-pre-pit signal LPPS2 corresponding to FIG. 2B. Although under such condition the four analog receiving signals A, B, C, and D are a little bit unbalance, the increment of the error generated by the unbalance of the push pull signal (A+D)-(B+C) is much less than that the increment of the land-pre-pit signal LPPS component. Therefore, by such method, the signal to noise ratio of the land-pre-pit signal LPPS can be increased and detecting land-pre-pit signal LPPS can be carried out effectively to thereby precisely obtain the start address information of burning the optical disc/disk Dsk2.

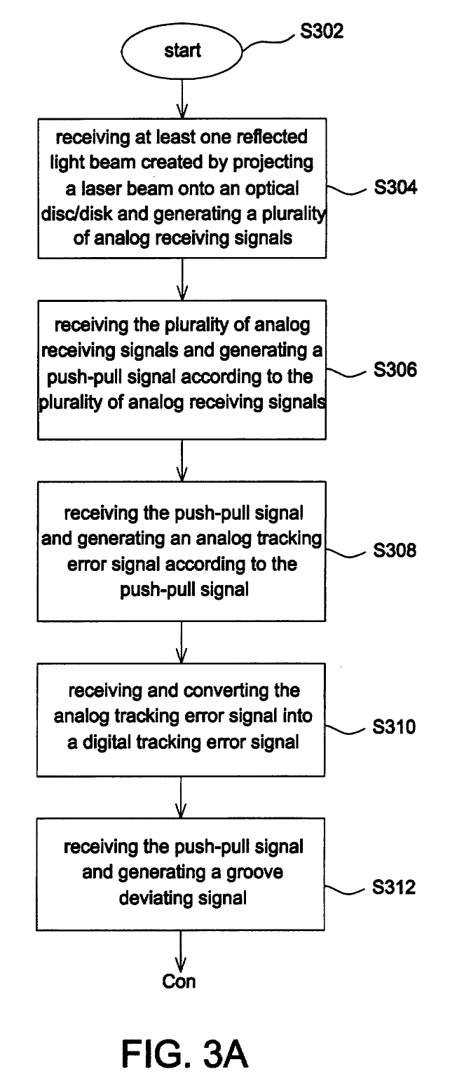

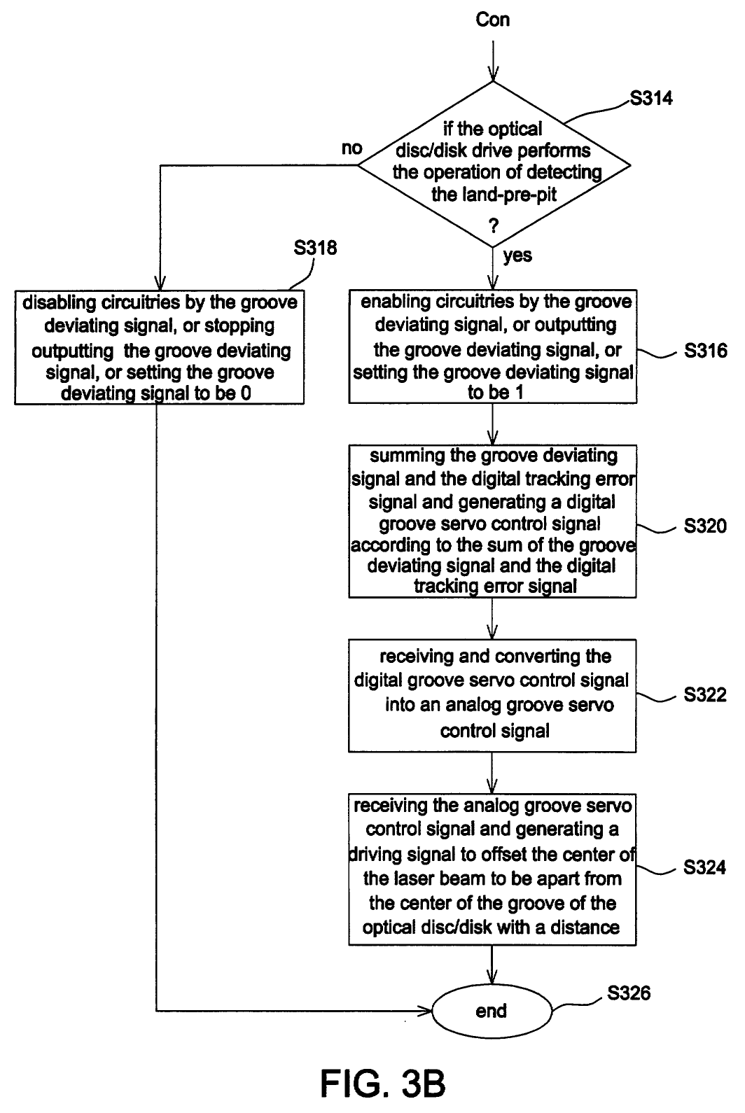

FIGS. 3A and 3B show the tracking control method for detecting land-pre-pit signal according to one embodiment of the invention. The method for an optical disc/disk compliant with the DVD-R/RW specification comprises the following steps:

Step S302: start;

Step S304: receiving at least one reflected light beam created by projecting a laser beam onto an optical disc/disk and generating a plurality of analog receiving signals;

Step S306: receiving the plurality of analog receiving signals and generating a push-pull signal according to the plurality of analog receiving signals;

Step S308: receiving the push-pull signal and generating an analog tracking error signal according to the push-pull signal;

Step S310: receiving and converting the analog tracking error signal into a digital tracking error signal;

Step S312: receiving the push-pull signal and generating a groove deviating signal, that is a bias or an offset;

Step S314: determining if the optical disc/disk drive performs the operation of detecting the land-pre-pit and jumping to Step S316 if yes and to Step S318 if no;

Step S316: enabling circuitries by the groove deviating signal, or outputting the groove deviating signal, or setting the groove deviating signal to be 1; and jumping to Step S320;

Step S318: disabling circuitries by the groove deviating signal, or stopping outputting the groove deviating signal, or setting the groove deviating signal to be 0; and jumping to Step S326;

Step S320: summing the groove deviating signal and the digital tracking error signal and generating a digital groove servo control signal according to the sum of the groove deviating signal and the digital tracking error signal;

Step S322: receiving and converting the digital groove servo control signal into an analog groove servo control signal;

Step S324: receiving the analog groove servo control signal and generating a driving signal to offset the center of the laser beam to be apart from the center of the groove of the optical disc/disk with a distance;

Step S326: end.

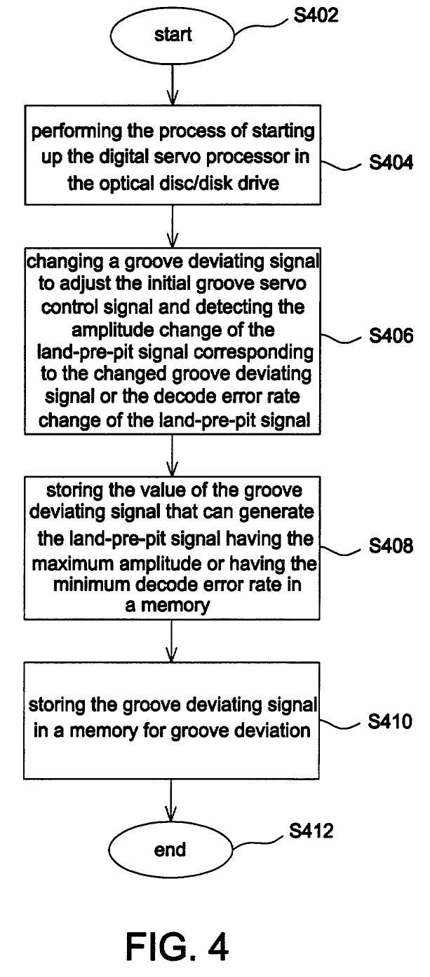

It should be noted that the analog groove servo control signal TSa can utilize the driving device 25 to move the laser beam to the most clearly read position from the land-pre-pit signal LPPS in order to provide the groove deviating signal AS for the optical disc/disk drive to accurately detect the land-pre-pit signal LPPS. Therefore, the one embodiment of the invention provides a groove servo signal generating method, as shown in FIG. 4. Certainly, the method is also for an optical disc/disk compliant with the DVD-R/RW specification. The method comprises the following steps:

Step S402: start;

Step S404: performing the process of starting up the digital servo processor in the optical disc/disk drive;

Step S406: changing a groove deviating signal to adjust the initial groove servo control signal and detecting the amplitude change of the land-pre-pit signal corresponding to the changed groove deviating signal or the decode error rate change of the land-pre-pit signal, where the groove deviating signal is a bias or an offset and changing the groove deviating signal may be achieved by sequentially decreasing or increasing the value or other methods, such as increasing by every other integer, 1, 3, 5, 7, 9, . . .

Step S408: storing the value of the groove deviating signal that can generate the land-pre-pit signal having the maximum amplitude or having the minimum decode error rate in a memory;

Step S410: storing the groove deviating signal in a memory for groove deviation;

Step S412: end.

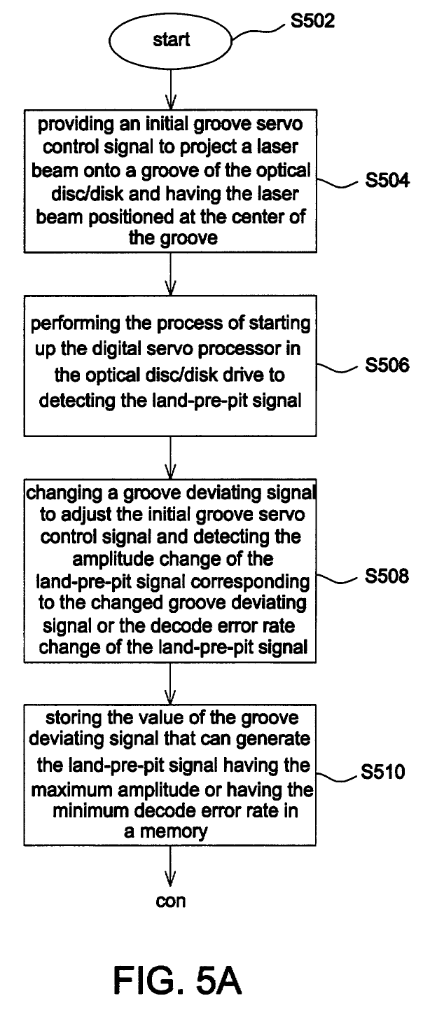

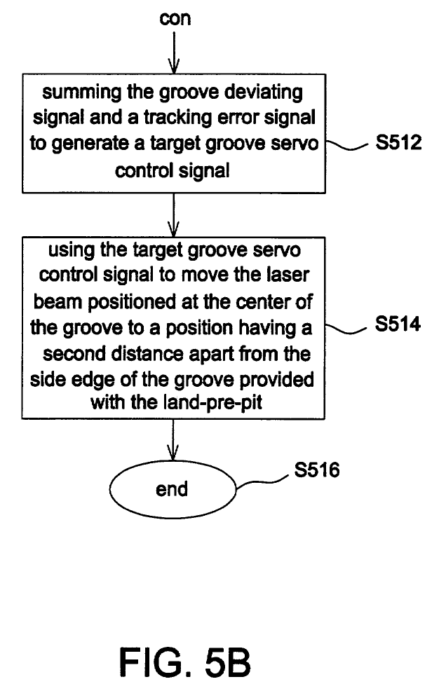

Furthermore, one embodiment of the invention provides a tracking pre-adjustment method for detecting the land-pre-pit signal, as shown in FIGS. 5A and 5B. The method is carried out before the optical disc/disk drive to search the groove deviating signal AS corresponding to the maximum amplitude or the minimum decode error rate of the land-pre-pit signal. This groove deviating signal AS is subsequently used while detecting the land-pre-pit signal. The method comprises the following steps:

Step S502: start;

Step S504: providing an initial groove servo control signal to project a laser beam onto a groove of the optical disc/disk and having the laser beam positioned at the center of the groove wherein the center position of the groove has a first distance apart from the side edge of the groove provided with the land-pre-pit;

Step S506: performing the process of starting up the digital servo processor in the optical disc/disk drive to detecting the land-pre-pit signal;

Step S508: changing a groove deviating signal to adjust the initial groove servo control signal and detecting the amplitude change of the land-pre-pit signal corresponding to the changed groove deviating signal or the decode error rate change of the land-pre-pit signal, where the groove deviating signal is a bias or an offset;

Step S510: storing the value of the groove deviating signal that can generate the land-pre-pit signal having the maximum amplitude or having the minimum decode error rate in a memory;

Step S512: summing the groove deviating signal and a tracking error signal to generate a target groove servo control signal;

Step: S514: using the target groove servo control signal to move the laser beam positioned at the center of the groove to a position having a second distance apart from the side edge of the groove provided with the land-pre-pit where the second distance is shorter than the first distance;

Step S516: end.

It should be noted that the tracking control system and the tracking control method in the above embodiments according to the invention are used to process the burned optical disc/disk compliant with DVD-R/RW specification. Certainly, the tracking control system and the tracking control method in the other embodiments according to the invention can be used to process a blank optical disc/disk compliant with DVD-R/RW specification.

Although the present invention has been fully described by way of examples with reference to the accompanying drawings, it should be noted that various changes and modifications will be apparent to those skilled in the art.

What is claimed is:

1. A tracking servo control system for optical disc/disk drive, comprising:
an optical processing unit for generating a plurality of analog receiving signals according to at least one reflected light beam created by projecting a laser beam from the optical processing unit onto an optical disc/disk;
an analog front-end device for receiving the plurality of analog receiving signals and generating a push-pull signal and an analog tracking error signal according to the plurality of analog receiving signals;
a groove control unit for receiving the push-pull signal and generating a groove deviating signal according to the push-pull signal;
a digital servo processor that converts the analog tracking error signal into a digital tracking error signal, sums the groove deviating signal and the digital tracking error signal, and performs signal equalization and digital-to-analog conversion according to the sum of the groove deviating signal and the digital tracking error signal so as to generate an analog groove servo control signal; and
a driving device for generating a driving signal according to the analog groove servo control signal to thereby control the laser beam emitted from the optical processing unit projected onto the position of a groove on the optical disc/disk.

2. The tracking servo control system according to claim 1, wherein a plurality of land-pre-pits are disposed in one side edge area of the groove.

3. The tracking servo control system according to claim 2, wherein the laser beam is projected onto a center position of the groove with a first distance apart from the side edge of the groove having the land-pre-pits when the optical disc/disk drive reads the data contained in the groove.

4. The tracking servo control system according to claim 3, wherein the laser beam position is moved from the center position of the groove to a position with a second distance apart from the side edge of the groove when the optical disc/disk drive detects the signal of the land-pre-pits and the second distance is shorter than the first distance.

5. The tracking servo control system according to claim 1, wherein the analog front-end device comprises:
a push-pull signal generator for receiving the plurality of analog receiving signals and generating a push-pull signal according to the plurality of analog receiving signals; and
a tracking error signal generator for receiving the push-pull signal and generating the analog tracking error signal according to the push-pull signal.

6. The tracking servo control system according to claim 1, wherein the digital servo processor comprises:
an analog-to-digital converter for receiving the analog tracking error signal and converting the analog tracking error signal into the digital tracking error signal;
a tracking servo equalizer for generating a digital groove servo control signal according to the sum of the digital tracking error signal and the groove deviating signal; and
a digital-to-analog converter for receiving the digital groove servo control signal and converting the digital groove servo control signal into the analog groove servo control signal.

7. The tracking servo control system according to claim 6, wherein the digital servo processor further comprises an adder for adding the digital tracking error signal and the groove deviating signal.

8. The tracking servo control system according to claim 1, wherein the groove deviating signal is a bias or an offset.

9. The tracking servo control system according to claim 1, wherein the optical disc/disk is an optical disc/disk compliant with the -R or -RW specification.

10. A tracking servo control system for optical disc/disk drive, comprising:
an optical processing unit for generating a plurality of analog receiving signals according to at least one reflected light beam created by a laser beam projected from the optical processing unit onto an optical disc/disk;
a push-pull signal generator for receiving the plurality of analog receiving signals and generating a push-pull signal according to the plurality of analog receiving signals;
a tracking error signal generator for receiving the push-pull signal and generating an analog tracking error signal according to the push-pull signal;
a groove control unit for receiving the push-pull signal and generating a groove deviating signal according to the push-pull signal;
a servo processor for generating a groove servo control signal according to the analog tracking error signal and the groove deviating signal; and
a driving device for generating a driving signal according to the groove servo control signal to thereby control the laser beam emitted from the optical processing unit projected onto the position of a groove on the optical disc/disk.

11. The tracking servo control system according to claim 10, wherein a plurality of land-pre-pits are provided in one side edge of the groove.

12. The tracking servo control system according to claim 11, wherein the laser beam is projected onto a center position of the groove with a first distance apart from the side edge of the groove having the land-pre-pit when the optical disc/disk drive reads the data contained in the groove; the laser beam position is moved from the center position of the groove to a position with a second distance apart from the side edge of the groove having the land-pre-pit when the optical disc/disk drive detects the signal of the land-pre-pit, and the second distance is shorter than the first distance.

13. The tracking servo control system according to claim 10, wherein the optical disc/disk is an optical disc/disk compliant with the -R or -RW specification.

14. The tracking servo control system according to claim 10, wherein the servo processor comprises:
an analog-to-digital converter for receiving the analog tracking error signal and converting the analog tracking error signal into a digital tracking error signal;
a tracking servo equalizer for generating a digital groove servo control signal in accordance with the sum of the digital tracking error signal and the groove deviating signal; and
a digital-to-analog converter for receiving the digital groove servo control signal and converting the digital groove servo control signal into the groove servo control signal.

15. The tracking servo control system according to claim 14, further comprising an adder for adding the digital tracking error signal and the groove deviating signal.

16. The tracking servo control system according to claim 10, wherein the groove servo control signal is a digital signal.

17. The tracking servo control system according to claim 10, wherein the groove deviating signal is a digital signal.

18. A tracking calibration method for detecting the land-pre-pit signal of an optical disc/disk drive system, comprising:
detecting a land-pre-pit signal according to an initial groove servo control signal;
modifying the initial groove servo control signal according to a plurality of groove deviating signals and detecting the land-pre-pit signal, individually and repeatedly; and
choosing an optimized groove deviating signal among the plurality of groove deviating signals and storing the corresponding data of the optimized groove deviating signal into a memory device.

19. The tracking calibration method according to claim 18, wherein the optimized groove deviating signal is corresponding to a land-pre-pit signal having a maximum detected amplitude or a minimum decode error rate.

20. The tracking calibration method according to claim 18, wherein the plurality of groove deviating signals are different from each other.

21. A tracking control method for detecting the land pre-pit signal of an optical disc/disk drive system, comprising:
projecting a laser beam onto a groove of the optical disc/disk and having the laser beam positioned at the center of the groove wherein the center position of the groove has a first distance apart from the side edge of the groove provided with a plurality of land-pre-pits; and
providing a groove deviating signal for moving the laser beam positioned at the center of the groove to a position having a second distance apart from the side edge of the groove provided with the land-pre-pits;
wherein the second distance is shorter than the first distance.

22. The tracking control method according to claim 21, wherein the optical disc/disk is an optical disc/disk compliant with the -R or -RW specification.
